(19) United States
(12) Patent Application Publication
(10) Pub. No.: US 2015/0142676 A1
(43) Pub. Date: May 21, 2015

(54) SYSTEMS AND METHODS FOR MANAGING AUTHORED CONTENT GENERATION, APPROVAL, AND DISTRIBUTION

(71) Applicant: Tweddle Group, Clinton Township, MI (US)

(72) Inventors: Patrick McGinnis, Rochester, MI (US); James Brei, Milford, MI (US); Michael Martin Flaherty, Oxford, MI (US); Joseph O'Deven, Auburn Hills, MI (US)

(21) Appl. No.: 14/540,829

(22) Filed: Nov. 13, 2014

Related U.S. Application Data
(60) Provisional application No. 61/903,780, filed on Nov. 13, 2013.

(51) Int. Cl. G06Q 10/10

(52) U.S. Cl. CPC G06Q 10/103
USPC 705/301

(57) ABSTRACT

A review management system/content management system (RMS/CMS system) manages the collection and review of blocks of unreviewed authored content by original equipment manufacturer (OEM) designated reviewers. OEM designated reviewers are able to edit and add comments that are logically associated by the RMS/CMS system with a block of unreviewed authored content. The RMS/CMS system logically associates each block of approved authored content with one or more topics included in the documentation that accompanies an OEM produced vehicle. The RMS/CMS system receives or otherwise accesses a bill of materials (BOM) associated with a vehicle and selects blocks of approved authored content for inclusion in the documentation accompanying the respective vehicle. The RMS/CMS system selects system blocks of approved authored content based on topics identified by the systems and components included on the BOM associated with the vehicle. The RMS/CMS system generates the documentation using OEM specific templates.

### BACKGROUND

1. Technical Field

The present disclosure generally relates to composition and delivery of informational content related to one or more items of manufacture, more specifically the present disclosure relates to approval, revision, and commentary processes for authored content associated with an item of manufacture.

2. Description of the Related Art

Modern items of manufacture include a large number of components sourced from a number of suppliers. Manufacturers assemble the various components based on a bill of material or similar manufacturing specification to provide any number of products, each having a similar or different number or combination of components. This modular assembly of parts lends itself to a similar personnel structure supporting the production of the items of manufacture.

For example, a motor vehicle may include thousands of parts assembled into a number of systems (e.g. interior, drivetrain, engine, emissions, braking, electrical, entertainment, and the like). Each of the systems includes any number of components and sub-systems that vary based on the complexity of the system. An original equipment manufacturer (“OEM”) typically assigns a number of subject matter experts (e.g., engineers, technical experts) to oversee and improve development and production process of the various components and systems used in vehicle production. An OEM may also assign systems managers (or similar) to more complex systems or systems requiring a large number of components or sub-systems. An OEM may assign one or more platform managers who are responsible for a particular vehicle model or a portion of overall vehicle production. Thus, a hierarchy of subject matter experts, system managers, and platform manager support vehicle platform produced by an OEM.

Vehicles evolve over time, a model year 2014 make and model vehicle may be very similar to a vehicles of the same make and model produced over the last 3 or 4 years, or may be a virtually all new vehicle that has not been previously produced. Throughout the vehicle design and production lifecycle, the components, sub-systems, and systems used in the vehicle may become obsolete or lower cost/better performing alternatives may become available. Such changes are reflected not only in the vehicle on the production floor, but also must percolate through the entire engineering and product support infrastructure (e.g., legal, management, supply chain, etc.). For example, content in documentation supplied with the vehicle (owner's manuals, quick start guides, user's guides, maintenance manuals, etc.) may be revised, updated, and/or replaced with newer content to reflect differences in the components and sub-systems used to produce the vehicle. Each of these revised, updated, or new sections must pass through a review and approval process defined at least in part by the OEM producer of the vehicle. Review of a manual for a manufactured item such as a vehicle may involve a thousand people (e.g., engineers, mechanics, lawyers). Given the large number of vehicular components, sub-systems, and systems found in modern vehicles and considering the rapid rate of such vehicular components, sub-systems, and systems, one can readily appreciate the logistical challenge of ensuring all of the necessary reviewers examine and approve the revised or new subject matter prior to inclusion in documentation accompanying a vehicle. One can also appreciate the need for such reviews to occur in a timely manner that is coordinated with the production of the vehicle.

### BRIEF SUMMARY

Suppliers provide both the components and systems used to produce a vehicle, and pieces of authored content for review by the vehicle OEM (i.e., blocks of authored content to be reviewed). The vehicle OEM may also generate authored content, for example to reflect the manner in which various components and/or systems combine within the vehicle. One or more third party sources may generate additional authored content, for example using primary source information provided by a vehicle OEM and/or vehicle component or systems suppliers. Authored content may include textual data, graphical data, image data, video data, audio data, audio/visual data, or any combination thereof. In some instances, the authored content may include a relatively small quantity of data, such as a single sentence, a single small graphic, or a single image and caption. In other instances, the authored content may include a relatively large quantity of data, such as an entire chapter, a complex graphic, or a video demonstrating a maintenance procedure. In some instances, each piece or portion of authored content is logically associated with at least one topic or subject found in one or more documents that typically accompany a vehicle and are provided to the vehicle owner and/or vehicle operator.

A review management system/content management system (“RMS/CMS system”) provides the ability to create, assemble, route, and track blocks of authored content through an OEM designated review process. By coordinating the authored content approval process with vehicle production information, the RMS/CMS system is able to provide timely reminders and notifications of pending authored content awaiting review to some or all of the OEM designated reviewers. In some instances, the RMS/CMS system may also provide notifications to management and/or production management personnel when a reviewer has not provided a timely approval or disapproval of authored content that the reviewer has been assigned to review.

In some instances, the RMS/CMS system facilitates the editing of authored content by one or more reviewers. The RMS/CMS system can track such changes, associating an individual reviewer's name and/or role with the change or edit to the authored content. By tracking such changes or edits, the RMS/CMS system advantageously provides an entire “review history” that is logically associated with respective pieces or portions of authored content included in a document. Such also provides a significant advantage in identifying with particularity a specific change made to a specific piece or portion of approved authored content appearing in a document.

In some instances, the RMS/CMS system facilitates the entry of comments by reviewers of authored content. The RMS/CMS system may store and/or logically associate such comments with the respective pieces or portions of authored content whether approved or unapproved. By tracking such comments, the RMS/CMS system advantageously allows future reviewers, legal staff, management staff, and/or production staff to determine why a particular reviewer disapproved a piece or portion of authored content or why a particular reviewer changed previously approved authored content. Once a piece or portion of authored content has completed the OEM-designated review process, the RMS/CMS system changes the status of the authored content to be either approved authored content or unapproved authored content dependent upon receipt of a final approval or disapproval by the OEM designated reviewers.

The RMS/CMS system stores any number of variants of approved authored content. Such variants may include substantively identical pieces or portions of approved authored content in different languages. Such variants may include substantively identical pieces or portions of approved authored content for use in different markets. Such variants may include specialized pieces or portions of approved authored content for use in particular markets having one or more unique document requirements (e.g., unique legal disclosure requirements, unique consumer information requirements, unique document form and/or format requirements).

The RMS/CMS accesses or receives a bill of material (BOM) for each vehicle produced by the OEM from one or more OEM production management systems, such as an enterprise or business management system. Using the accessed or received BOM information, the RMS/CMS system identifies the various components or systems used in the vehicle and the various topics for inclusion in documentation such as owner's manuals and user's guides that accompany the vehicle. Using the BOM information, the RMS/CMS system autonomously identifies any particular or unique language or market variant approved authored content for inclusion in the documentation that accompanies the vehicle. Using the BOM information, the RMS/CMS system autonomously identifies any particular or unique documentation requirements, such as a required form or format of the documentation supplied with or accompanying the vehicle.

The RMS/CMS system includes one or more nontransitory storage media in which OEM-specific or OEM-provided documentation templates or similar documentation “shells” or “skeletons” may be stored. Using the accessed or received BOM information, the RMS/CMS system autonomously selects an appropriate OEM documentation template and autonomously selects and populates the template with pieces or portions of approved authored content. The RMS/CMS system generates the resultant document in an OEM approved format using OEM approved authored content to provide a seamless, unified, document. The RMS/CMS system selects pieces or portions of approved authored content for inclusion in documentation accompanying a vehicle based at least in part on the topics autonomously determined by and associated with the components or systems included in the respective vehicle BOM. For example, the RMS/CMS system will include portions or pieces of approved authored content related to the topic of “convertible top operation” only in physical and/or electronic documents supplied with or accompanying vehicles having an associated BOM that includes one or more components or systems determined by the RMS/CMS system as being associated with a convertible top.

A method of operation in a vehicle component authoring system comprising at least one processor and at least one nontransitory processor-readable medium communicatively coupled to the at least one processor may be summarized as including: for each of a number of documents, storing a set of authored content by the at least one processor to the at least one nontransitory processor-readable medium, the stored set of authored content including authored content for each of a plurality of topics related to the vehicle; for each of a plurality of systems and components which are each represented by a respective identifier in a bill of materials for the vehicle, storing a logical relationship between the respective system or the respective component of the vehicle and a respective one of the topics, by the at least one processor to the at least one nontransitory processor-readable medium; for each of a plurality of systems and components which are each represented by a respective identifier in a bill of materials for the vehicle, storing a logical relationship between the respective system or the respective component of the vehicle and at least one respective role responsible for the respective system or the respective component, by the at least one processor to the at least one nontransitory processor-readable medium; and monitoring approval or lack of approval of at least a portion of the set of authored content by the at least one processor.

Monitoring approval or lack of approval of at least a portion of the set of authored content by the at least one processor may include monitoring approval or lack of approval on a topic level, on a system or component level, and on a complete authored document level. Storing a logical relationship between the respective system or the respective component of the vehicle and at least one respective role responsible for the respective system or the respective component may include storing a respective logical relationship between the system or the component and an identifier that identifies at least one of a position or a title. The method may further include storing a logical relationship between the identifier that identifies at least one of the position or the title and an identifier that uniquely identifies an individual currently assigned to the respective position or the respective title. The method may further include from time-to-time, updating the stored logical relationship between the identifier that identifies at least one of the position or the title and the identifier that uniquely identifies the individual currently assigned to the respective position or the respective title as the individual currently assigned to the respective position or the respective title changes. Storing a logical relationship between the respective system or the respective component of the vehicle and at least one respective role responsible for the respective system or the respective component may include storing a respective logical relationship between the system or the component and an identifier that identifies a plurality of at least one of a position or a title. Monitoring approval or lack of approval of the authored content of the set of authored content may include, for each system or each component, storing a set of information which indicates which of the respective roles logically associated with the respective system or respective component have approved the respective portion of the authored content. Monitoring approval or lack of approval of the authored content of the set of authored content may include identifying any of the systems or the components which have not been approved by all of the respective roles logically associated with the respective system or the respective component, and causing a notification indicative of the lack of approval to be provided. Causing a notification indicative of the lack of approval to be provided may include causing a first electronic communication to be provided to any individuals who are logically assigned to the respective roles logically associated with the respective system or the respective component, and who have not yet approved the authored content logically associated with the respective system or the respective component. Causing a notification indicative of the lack of approval to be provided may further include, after causing the first electronic notification to be provided, causing a second electronic communication to be provided to any individuals who are logically assigned to the respective roles logically associated with the respective system or the respective component, and who have still not yet approved the authored content logically associated with the respective system or the respective component. Causing a notification indicative of the lack of approval to be provided may include, causing a third electronic communication to be provided to at least one supervisor of any individuals who are logically assigned to the respective roles logically associated with the respective system or respective component and which individuals have not yet approved the authored content logically associated with the respective system or the respective component. Causing a notification indicative of the lack of approval to be provided may further include, waiting after the provision of the second electronic communication before causing the third electronic communication to be provided to the at least one supervisor. Causing a notification indicative of the lack of approval to be provided may further include determining when to cause the third electronic communication to be provided to the at least one supervisor based on a release schedule. Causing a notification indicative of the lack of approval to be provided may further include causing a fourth electronic communication to be provided to any individuals who are logically assigned to a role that provides overall responsibility for the authored content for the vehicle. Causing a notification indicative of the lack of approval to be provided may further include, waiting after the provision of the third electronic communication before causing the fourth electronic communication to be provided to the at least one supervisor. Causing a notification indicative of the lack of approval to be provided may further include determining when to cause the provision of the fourth electronic communication to the at least one supervisor based on a release schedule. Causing a notification indicative of the lack of approval to be provided may include causing an electronic communication to be provided to at least one supervisor of any individuals who are logically assigned to the respective roles logically associated with the respective system or respective component and which individuals have not yet approved the authored content logically associated with the respective system or the respective component. 18. The method of claim 1 wherein the set of authored content may be at least one of the plurality of systems and components which is represented by at least one respective part identifier in the bill of materials for the vehicle, and storing a logical relationship between the respective system or the respective component of the vehicle and at least one respective role responsible for the respective system or the respective component may include storing a respective logical relationship between the set of authored content and at least one respective role responsible for the set of authored content. Monitoring approval or lack of approval of at least a portion of the set of authored content by the at least one processor may include monitoring approval or lack of approval for each logically associated role on a topic level, on a system or component level, and on a complete authored document level. The method may further include tracking by the at least one processor changes to the authored content. Tracking by the at least one processor changes to the authored content may include storing a logical relationship between each change a respective unique identifier of a subject matter expert who was responsible for the change. The method may further include storing the changes as a respective annotation to the authored content. The method may further include tracking by the at least one processor comments made with respect to the authored content. Tracking by the at least one processor comments made with respect to the authored content may include storing a logical relationship between each comment a respective unique identifier of a subject matter expert who was responsible for the comment. The method may further include storing the comments as a respective annotation to the authored content. Storing a set of authored content by the at least one processor to the at least one nontransitory processor-readable medium, may include storing a variant of authored content for each of a plurality of topics related to the vehicle. The stored authored content may be in a first language and storing a variant of authored content for each of a plurality of topics related to the vehicle may include storing a version of the authored content in a second language different from the first language. The stored authored content may be customized for a first market and storing a variant of authored content for each of a plurality of topics related to the vehicle may include storing a version of the authored content customized for a second market, different than the first market. Storing a version of the authored content customized for a second market, different than the first market, may include storing a variant of the authored content for the second market with at least one system or component that is different from the stored authored content for the first market. Storing a version of the authored content customized for a second market, different than the first market, may include storing a variant of the authored content for the second market with at least one safety warning that is different from the stored authored content for the first market. The identifiers in the bill of materials may correspond to respective original equipment manufacturer part identifiers for the respective vehicle.

An authoring system may be summarized as including at least one processor; at least one nontransitory processor-readable medium communicatively coupled to the at least one processor, and which stores at least one of processor-executable instructions or data, where for each of a number of documents: the at least one processor stores a set of authored content to the at least one nontransitory processor-readable medium, the stored set of authored content including authored content for each of a plurality of topics related to the vehicle; for each of a plurality of systems and components which are each represented by a respective identifier in a bill of materials for the vehicle, the at least one processor stores a logical relationship between the respective system or the respective component of the vehicle and a respective one of the topics to the at least one nontransitory processor-readable medium; for each of a plurality of systems and components which are each represented by a respective identifier in a bill of materials for the vehicle, the at least one processor stores a logical relationship between the respective system or the respective component of the vehicle and at least one respective role responsible for the respective system or the respective component to the at least one nontransitory processor-readable medium; and the at least one processor monitors approval or lack of approval of at least a portion of the set of authored content.

The at least one processor may monitor approval or lack of approval on a topic level, on a system or component level, and on a complete authored document level. the at least one processor may store a respective logical relationship between the system or the component and an identifier that identifies at least one of a position or a title. The at least one processor may further store a logical relationship between the identifier that identifies at least one of the position or the title and an identifier that uniquely identifies an individual currently assigned to the respective position or the respective title to the at least one nontransitory processor-readable medium. From time-to-time, the at least one processor may further update the stored logical relationship between the identifier that identifies at least one of the position or the title and the identifier that uniquely identifies the individual currently assigned to the respective position or the respective title as the individual currently assigned to the respective position or the respective title changes. The at least one processor may store a respective logical relationship between the system or the component and an identifier that identifies a plurality of at least one of a position or a title to the at least one nontransitory processor-readable medium. For each system or each component, the at least one processor may store a set of information to the at least one nontransitory processor-readable medium which indicates which of the respective roles logically associated with the respective system or respective component have approved the respective portion of the authored content. The at least one processor may identify any of the systems or the components which have not been approved by all of the respective roles logically associated with the respective system or the respective component, and may cause a notification indicative of the lack of approval to be provided. The at least one processor may cause a first electronic communication to be provided to any individuals who are logically assigned to the respective roles logically associated with the respective system or the respective component, and who have not yet approved the authored content logically associated with the respective system or the respective component. After causing the first electronic notification to be provided, the at least one processor may cause a second electronic communication to be provided to any individuals who are logically assigned to the respective roles logically associated with the respective system or the respective component, and who have still not yet approved the authored content logically associated with the respective system or the respective component. The at least one processor may cause a third electronic communication to be provided to at least one supervisor of any individuals who are logically assigned to the respective roles logically associated with the respective system or respective component and which individuals have not yet approved the authored content logically associated with the respective system or the respective component. The at least one processor may wait after the provision of the second electronic communication before causing the third electronic communication to be provided to the at least one supervisor. The at least one processor may determine when to cause the third electronic communication to be provided to the at least one supervisor based on a release schedule. The at least one processor may further cause a fourth electronic communication to be provided to any individuals who are logically assigned to a role that provides overall responsibility for the authored content for the vehicle. The at least one processor may wait after the provision of the third electronic communication before causing the fourth electronic communication to be provided to the at least one supervisor. Causing a notification indicative of the lack of approval to be provided may further include determining when to cause the provision of the fourth electronic communication to the at least one supervisor based on a release schedule. The set of authored content may be at least one of the plurality of systems and components which is represented by at least one respective part identifier in the bill of materials for the vehicle, and the at least one processor may store a respective logical relationship in the at least one nontransitory processor-readable medium between the set of authored content and at least one respective role responsible for the set of authored content. The at least one processor may monitor approval or lack of approval for each logically associated role on a topic level, on a system or component level, and on a complete authored document level. The authoring system may further include tracking by the at least one processor at least one of changes to the authored content or comments regarding the authored content. The at least one processor may store a logical relationship between each change or comment and a respective unique identifier of a subject matter expert who was responsible for the change or comment. The at least one processor may store the changes or the comments in the at least one nontransitory processor-readable medium as a respective annotation to the authored content. The at least one processor may store a variant of authored content to the at least one nontransitory processor-readable medium for each of a plurality of topics related to the vehicle. The stored authored content may be in a first language and the at least one processor may store a version of the authored content in a second language different from the first language to the at least one nontransitory processor-readable medium. The stored authored content may be customized for a first market and the at least one processor may store a version of the authored content customized for a second market, different than the first market to the at least one nontransitory processor-readable medium. The at least one processor may store to the at least one nontransitory processor-readable medium a variant of the authored content for the second market with at least one system or component that is different from the stored authored content for the first market. The at least one processor may store to the at least one nontransitory processor-readable medium a variant of the authored content for the second market with at least one safety warning that is different from the stored authored content for the first market.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an example system for managing the authored content review and approval processes and producing electronic and physical documents using blocks of approved authored content logically associated with topics autonomously selected using at least a bill of material associated with a respective vehicle, according to one non-limiting illustrated embodiment.

FIG. 2 is a block diagram of an example system for managing the review, revision, and commenting processes related to authored content and producing electronic and physical documents using one of several variants of approved authored content based on data included in a bill of material associated with a particular vehicle make and model, according to one non-limiting illustrated embodiment.

FIG. 3 is a high-level flow diagram of a method of logically associating components or systems included on a vehicular bill of material with one or more document topics and autonomously selecting pieces or portions of approved authored content associated with those topics for inclusion in documentation supplied with or accompanying the vehicle, according to one non-limiting illustrated embodiment.

FIG. 4 is a flow diagram of a method of autonomously generating a notification responsive to a failure of an OEM designated reviewer to timely review authored content communicated to the respective reviewer by the RMS/CMS system, according to one non-limiting illustrated embodiment.

FIG. 5 is a flow diagram of a method of autonomously tracking edits or changes made by an OEM designated reviewer to either a piece of approved authored content or a piece of unapproved authored content communicated to the respective reviewer by the RMS/CMS system, according to one non-limiting illustrated embodiment.

FIG. 6 is a flow diagram of a method of autonomously tracking comments made by an OEM designated reviewer to either a piece of approved authored content or a piece of unapproved authored content communicated to the respective reviewer by the RMS/CMS system, according to one non-limiting illustrated embodiment.

FIG. 7 is a flow diagram of a method of autonomously storing a number of variants of approved authored content logically associated with a topic, according to one non-limiting illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing devices, automotive head units, portable communication devices, manufacturing processes, document, audio, and video editing processes, the content and form of product owner's guides and maintenance manuals, and the like are not been discussed in detail.

Unless the context requires otherwise, throughout the specification and claims that follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment.

The use of ordinals such as first, second and third does not necessarily imply a ranked sense of order, but rather may only distinguish between multiple instances of an act or structure.

Reference to an “owner's manual” or a “user's guide” means any printed or electronic publication, document, or file that includes information relevant to the use and/or operation of one or more aspects of a manufactured item, for example a vehicle, with which the owner's manual and/or user's guide is associated.

Reference to a “maintenance manual” means any printed and/or electronic publication, document, or file that includes information relevant to the maintenance, repair, care, or upkeep of one or more aspects of a manufactured item, for example a vehicle, with which the maintenance manual is associated.

Reference to a “component” or the plural “components” means any component, device, feature, system, or sub-system present in or on a vehicle. Such components may include mechanical components, electrical components, and electromechanical components. Such components may also include features implemented either as hardware or as features implemented in hardware based at least in part on the execution of software by a dedicated processor in the vehicle or item of manufacture (e.g., a user interface on a vehicle head unit).

Reference to “authored content” refers to any content related to one or more components or systems included in an item of manufacture, for example a vehicle. Authored content may include textual data, video data, audio data, graphical data, audio/visual data or any combination thereof. Authored content may be in tangible or electronic (e.g., digital) form and may be provided as one or more computer or machine-readable files and/or data sets. The RMS/CMS system provides pieces or portions of authored content to any number and/or sequence of original equipment manufacturer (“OEM”) designated reviewers for review and approval or disapproval for inclusion in documentation supplied with or accompanying an item of manufacture. Portions or pieces of authored content that are designated by some or all of the OEM designated reviewers as approved for use in documents supplied with or accompanying an item of manufacture may be referred to as “approved authored content.” Portions or pieces of authored content that are designated by some or all of the OEM designated reviewers as NOT approved for use in documents supplied with or accompanying an item of manufacture may be referred to as “unapproved authored content.”

The headings and Abstract of the Disclosure provided herein are for convenience only and do not interpret the scope or meaning of the embodiments.

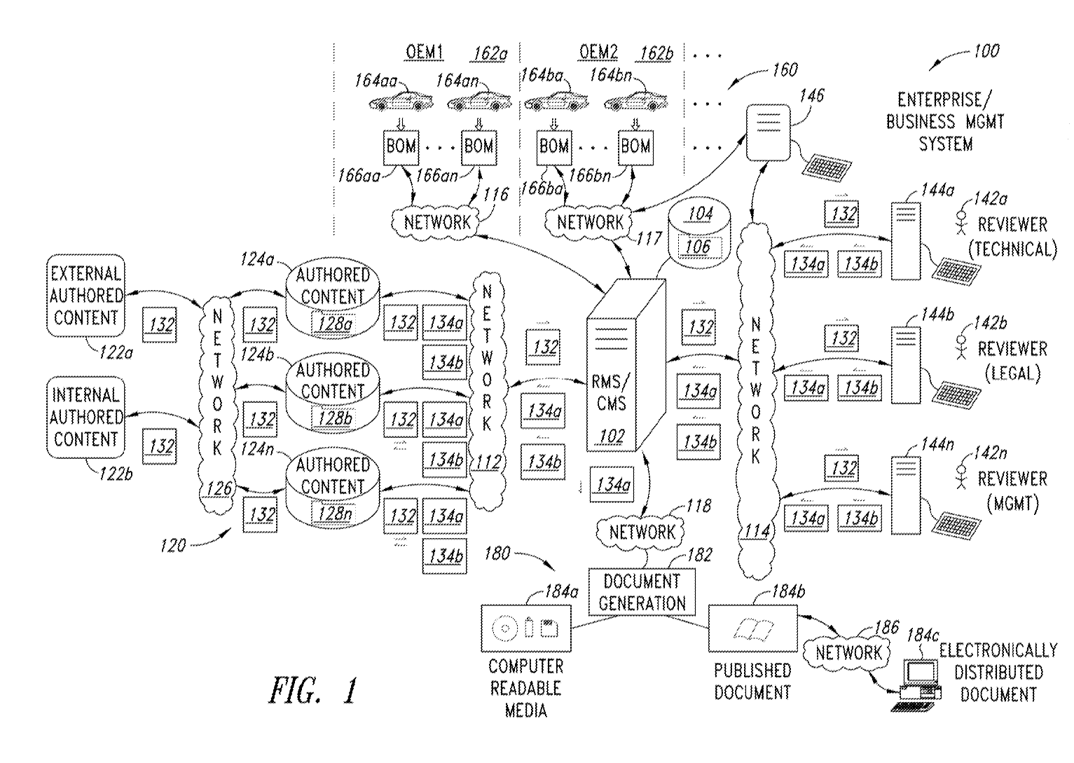

FIG. 1 shows a networked system 100 in which a review management system/content management system 102 (“RMS/CMS system 102”) autonomously selects one or more pieces or portions of approved authored content for inclusion in vehicular documentation. The RMS/CMS system 102 selects and assembles the pieces or portions of approved authored content into a document based on topics identified using the parts or components included on a bill of material associated with the respective item of manufacture. Thus, advantageously providing one or more documents that are “customized” or “specific” to the particular mix of components and/or systems included in the respective item of manufacture.

The RMS/CMS system 102 receives pieces or portions of authored content 132 from one or more internal sources 122a, one or more external sources 122b, and/or one or more third-party sources (collectively, “sources 122”). Each of the pieces or portions of authored content 132 contain information and other data associated at least one topic included in documentation accompanying one of a number of items of manufacture 164aa-164nn. Items of manufacture 164aa-164nn may include any manufactured item ranging in size and complexity from a relatively simple item such as a keychain to a relatively complex item such as a motor vehicle. In some instances, the items of manufacture may include any number of different make and model vehicles (collectively, “vehicles 164”) produced by any number of original equipment manufacturers (“OEMs”) 162a-162n (collectively, “OEMs 162”). For clarity and ease of discussion, from this point forward such items of manufacture are referred to all-inclusively as “vehicles 164” with the understanding that any item of manufacture may be substituted for the term “vehicle.”

The authored content receipt and storage module 120 receives pieces or portions of authored content 132 from any number of sources 122. External sources 122a may provide at least a portion of the authored content 132 received by the authored content receipt and storage module 120. For example, an external source 122a such as a component or system supplier or manufacturer may provide a number of pieces or portions of authored content 132 related to the care, operation, and/or maintenance of a particular component or system produced by the supplier and provided to an OEM 162 for inclusion in one or more vehicles 164. External sources 122a may provide authored content 132 in electronic format (e.g., as a computer file such as a Microsoft Word file or an Adobe Portable Document Format or “PDF” file) and additionally or alternatively, in one or more tangible formats (e.g., a printed format such as a book, booklet, cut sheet, brochure, and similar).

One or more internal sources 122b may also or may alternatively provide at least a portion of the authored content 132 received by the authored content receipt and storage module 120. For example, an internal source 122b such as an OEM subject matter expert (“SME”), an OEM systems manager, or an OEM platform manager may generate pieces or portions of authored content 132 associated with one or more components or systems or associated with one or more vehicles 164 produced by the OEM 162. In at least some instances, one or more internal sources 122b electronically generate pieces or portions of authored content 132 via the one or more enterprise or business management systems 146.

The received authored content 132 pieces or portions may variously include textual data, graphical data, image data, audio data, video data, audio/visual data, or combinations thereof. The received authored content 132 pieces or portions are stored or otherwise retained one or more data stores or databases 128a-128n (collectively, “databases 128”). In at least some instances, the RMS/CMS system 102 may create and maintain such databases 128 on one or more nontransitory storage media 124a-124n (collectively, “nontransitory storage media 124”). In at least some implementations, the RMS/CMS system 102 may autonomously poll or otherwise access one or more supplier 122 data stores or databases to obtain pieces or portions of authored content 132 logically associated with one or more vehicle makes and/or models produced by an OEM 162.

The RMS/CMS system 102 autonomously routes and tracks the pieces or portions of authored content 132 through an defined review and approval process that may include a defined number and/or sequence of OEM designated technical reviewers 142a, OEM designated legal reviewers 142b, and/or OEM designated management reviewers 142c (collectively, “reviewers 142”). As part of the review process, some or all reviewers 142 may propose and/or provide edits, changes or other alterations to some or all of a piece or portion of authored content 132. In some instances, reviewers 142 may approve authored content (i.e., a piece or portion of approved authored content 134a) for inclusion in documents 184 assembled and prepared by the RMS/CMS system 102. In some instances, reviewers 142 may disapprove authored content (i.e., a piece or portion of unapproved authored content 134b) to exclude the piece or portion of unapproved authored content 134b from documents 184 assembled and prepared by the RMS/CMS system 102.

The RMS/CMS system 102 selects approved authored content 134a for inclusion in one or more documents based at least in part on one or more vehicle related topics logically associated with the approved authored content 134a. At times, the source 122 that originally provided or supplied the respective piece or portion of authored content 132 may designate or provide data indicative of a logical association between a piece or portion of authored content 132 and one or more topics and/or components to the RMS/CMS system 102. For example, an external source 122a supplier of powertrain components may associate a topic such as “2WD Dodge Ram powertrain” with a rear differential component and a topic such as “4WD Dodge Ram powertrain” with a 4WD transfer case component. At other times, an OEM 162 may designate or provide data indicative of a logical association between a piece or portion of authored content 132 and one or more topics and/or components to the RMS/CMS system 102. At yet other times, the RMS/CMS system 102 may internally designate a logical association between the piece or portion of authored content 132 and one or more topics and/or components, for example using one or more machine-learning algorithms that use previous defined logical associations between topics and pieces or portions of authored content 132 to provide training examples.

Pieces or portions of approved authored content 134a can range in size and complexity from single sentences to entire chapters. In one example, a piece or portion of approved authored content 134a may include a sentence such as, “Cruise control is disengaged by pressing the brake pedal.” The RMS/CMS system 102 may include such a portion of approved authored content 134a in documents 184 accompanying only those vehicles 164 with which the topic of “cruise control” is logically associated based on the inclusion of one or more cruise control specific components or systems on the BOM 166 associated with the respective vehicle 164. Conversely, the RMS/CMS system 102 may exclude such a portion of approved authored content 134a in documentation 184 accompanying vehicles 164 with which the topic of “cruise control” is not logically associated based on an absence of cruise control specific components on the BOM 166 associated with the respective vehicle 164.

The RMS/CMS system 102 stores logical associations between a component or a system appearing on a bill of material and one or more topics related to the respective component or system. Thus, for example, the RMS/CMS system 102 may store data indicative of a logical association between one or more systems and/or components used on a vehicle 164 equipped with a convertible top and the topic “convertible top.” In another example, the RMS/CMS system 102 may store data indicative of a logical association between one or more systems and/or components used on a vehicle 164 equipped with a pushbutton ignition system and the topic “keyless ignition.” In another example, the RMS/CMS system 102 may store data indicative of a logical association between one or more systems and/or components used on a vehicle 164 equipped with a gasoline/electric hybrid powertrain and the topic “hybrid vehicles.”

The RMS/CMS system 102 provides an automated authored content tracking and approval notification module 140 that facilitates the tracking of pieces or portions of authored content 132 through an OEM review and approval process. In some instances, the OEM review and approval process may include one or more processes and/or reviewer sequences by OEM personnel. In other instances, the review and approval process may include one or more jointly administered and/or jointly performed processes (e.g., a review and approval process administered and performed by OEM personnel in cooperation or conjunction with component or system supplier personnel or other third parties). In some instances, an enterprise or business management system 146 may facilitate communication between the RMS/CMS system 102 and the reviewers 142, for example by providing text, audio, video, and/or audio/visual communications capabilities between the RMS/CMS system 102 and the reviewers 140, as well as between the reviewers 142.

Technical reviewers 142a can include one or more Subject Matter Experts (SMEs), one or more systems managers, and/or one or more platform managers. SMEs can include one or more persons or groups of persons having an enhanced or extended knowledge of a particular component and/or system (e.g., engineers, programmers, designers). In particular, an OEM SME may have knowledge specific to the manner in which the OEM 162 has altered or modified a component or system or the manner in which the OEM 162 employs or uses the component or system in one or more vehicles 164. Systems managers include individuals having overall responsibility for one or more systems, each of which may include one or more components or subsystems. For example, an OEM vehicular “powertrain” system manager may have overall responsibility for the transmission, rear differential, and driveline provided with one or more OEM 162 vehicles 164 (note that each of the transmission, rear differential, and driveline may have a separate OEM SME as well). OEM Platform managers include individuals having responsibility for a complete item of manufacture such as a particular make and model of automobile. Note that while the designations of SME, system manager and platform manager are provided for clarity and ease of discussion, other personnel or personnel having different titles and/or responsibilities may be assigned authored content reviewer responsibilities.

The RMS/CMS system 102 includes a production or manufacturing module 160 that autonomously identifies the systems and/or components used by any number of OEMs 162a-162n (collectively, “OEMs 162”) in assembling, manufacturing, or otherwise producing their respective vehicles 164. In some implementations, the manufacturing module 160 autonomously identifies some or all of the systems and/or components included in a particular vehicle 164 via a bill of material (“BOM”) 166aa-166nn (collectively, “BOMB 166”) or similar manufacturing or production order associated with each respective vehicle 164aa-164nn.

The RMS/CMS system 102 autonomously determines one or more topics for inclusion in the documentation 184 accompanying each vehicle 164 using a number of defined logical relationships between the systems and/or components used in producing a specific vehicle 164 as determined by the vehicle's BOM 166 and one or more topics. In such a manner, the RMS/CMS system 102 is able to advantageously generate OEM documents 184 specific to the topics of interest of the vehicle owner and/or vehicle operator based on the equipment (i.e., the systems and/or components) used in the production of the respective vehicle 164. Such documents are exemplified by the various owner's manuals, quick start guides, user's guides, system specific (e.g., entertainment, Bluetooth, global positioning system, and similar) operation documents, and similar documents. Advantageously, OEM documents tailored to a specific vehicle 164 can omit blocks of approved authored content 134a associated with topics unrelated to the vehicle 164 and may limit or even eliminate the need for “if equipped” or similar qualifiers found in “generic” vehicular documentation.

The RMS/CMS system 102 includes a document generation module 180 that autonomously generates one or more documents 184a-184n (collectively, “documents 184”). Such documents 184 are generated using pieces or portions of approved authored content 134a logically associated with one or more topics determined by the RMS/CMS system 102 as relevant to the respective vehicle 164 based at least in part on the components included in the BOM 166 for the respective vehicle 164. The document generation module 180 generates documents 184 in one or more OEM-selected templates and in one or more OEM-selected formats, that include but are not limited to, computer readable media 184a, tangible (e.g., printed) documents 184b, and electronically distributed documents 184n.

At least a portion of the autonomously generated documents produced by the RMS/CMS system 102 supplied with or accompanying a particular vehicle 164 include pieces or portions of approved authored content 134a autonomously selected by the RMS/CMS system 102 based on the BOM 166 associated with the respective vehicle 164. Additionally, in at least some instances, legal or regulatory requirements may dictate document content and/or format of at least a portion of the autonomously generated documents produced by the RMS/CMS system 102 for supply with a vehicle 164. For example, the United States National Highway Transportation Safety Administration (“NHTSA”) requires the provision of particularly worded safety information to vehicle purchasers in a printed (not computer readable or electronic) document format.

A number of pieces or portions of approved authored content 134a may include authored content provided by or in accordance with local, state, or federal requirements. For example, a piece or portion of approved authored content 134a may include one or more statements included in an Owner's Guide or Maintenance Manual for compliance with California Proposition 65 requirements. In another example, a piece or portion of approved authored content 134a may include one or more statements or sections regarding vehicle tire selection and rim compatibility included in an Owner's Guide or Maintenance Manual to comply with NHTSA requirements.

Pieces or portions of approved authored content 134a may be available in a number of versions. In some instances, such versions may correspond to various components or systems appearing in different makes, models and/or model year vehicles 164. For example, version “A” of a piece or portion of approved authored content 134a may be associated with the entertainment system provided in model year 2000 to 2002 Dodge Caravans. Version “B” of a piece or portion of approved authored content 134a may be associated with a modified entertainment system provided in model year 2003 Dodge Caravans. Version “C” of a piece or portion of approved authored content 134a may be associated with a further modified entertainment system provided in model year 2004-2008 Dodge Caravans.

In some instances, each version of a specific piece or portion of approved authored content 134a may correspond to different language versions of the block of approved authored content 134a. For example, an OEM may offer an English language owner's guide that includes version “EN” of a portion of approved authored content 134a, a Spanish language owner's guide that includes version “ES,” a substantively identical Spanish language version of the portion of approved authored content 134a, and a French language owner's guide that includes version “FR,” a substantively identical French version of the portion of approved authored content 134a. Each of these owner's guides would contain the same collection of approved authored content 134a, with each of the guides formed using different language versions of the same portions of approved authored content 134a.

In some instances, each version of a specific piece or portion of approved authored content 134a may correspond to different market versions of the block of approved authored content 134a. For example, version “1” of a piece of approved authored content 134a may be used in documentation 184 accompanying a vehicle 164 offered by an OEM 162 in a first market in which English units of measure are used (feet, miles per hour, pounds, gallons, quarts, ounces, etc.). A substantively identical version “2” of the piece of approved authored content 134a may be used in documentation 184 accompanying a vehicle 164 offered by an OEM 162 in a second market in which SI units of measure are used (meters, kilometers per hour, kilograms, liters, milliliters, etc.).

The one or more databases 128 receive pieces or portions of authored content 132 as electronic communications transported across one or more networks 126, such as the Internet. In some instances, all or a portion of the nontransitory storage media 124 may be internal to the RMS/CMS system 102. In other instances, all or a portion of the nontransitory storage media 124 may be external to the RMS/CMS system 102. The one or more databases 128 may be organized or arranged in any manner by the RMS/CMS system 102. For example, databases 128 may be organized by OEM, by supplier, by approved authored content, by unapproved authored content, or any combination thereof.

The automated tracking and approval notification module 140 provides notifications to one or more reviewers 142 of authored content 132 pending review by the respective reviewer 142. Additionally, the automated tracking and approval notification module 140 provides each reviewer 142 with the ability to approve or disapprove a piece of authored content 132. The automated tracking and approval notification module 140 generates electronic notifications (e.g., electronic messaging and/or e-mail) and communicates the notifications via network 114 to an electronic device 144a-144n associated with a respective reviewer 142a-142n.

In some instances, the RMS/CMS system 102 autonomously assigns reviewers 142 based on criteria supplied by the OEM 162. For example, an OEM 162 may designate John Adams and Mary Jones as SMEs for vehicle electrical systems. Upon receipt by the RMS/CMS system 102 of authored asset 132 portions logically associated with a topic such as “keyless ignition system”, the system 102 may autonomously generate and communicate notifications informing John Adams and Mary Jones that one or more authored asset 132 portions await their review. In other instances, the identities of reviewers 142 selected by an OEM 162, for example by an OEM enterprise or business management system 146 may be communicated to the RMS/CMS system 102.

The automated tracking and approval notification module 140 provides the reviewer 142 the ability to enter notes and/or comments for logical association with pieces or portions of authored content 132, pieces or portions of approved authored content 134a, and/or pieces or portions of unapproved authored content 134b. In some instances, the RMS/CMS system 102 provides the notes and/or comments logically associated with pieces or portions of authored content 132 to subsequent reviewers 142 to facilitate the review of the authored content 132 by the subsequent reviewers 142. In some instances, the RMS/CMS system 102 provides the notes and/or comments logically associated to other reviewers 142, legal personnel, and/or management to facilitate their evaluation of the approval or disapproval of one or more pieces or portions of authored content 132 by one or more reviewers 142.

The automated tracking and approval notification module 140 also autonomously provides notifications in the form of electronically communicated reminders of pieces or portions of authored content 132 awaiting review to those reviewers 142 assigned to review the content but who have not yet provided their review to the RMS/CMS system 102. In some instances, the RMS/CMS system 102 autonomously communicates such notifications at defined times or intervals after the initial assignment of the piece or portion of authored content 132 to the reviewer 142 (e.g., 1 week after assignment, 2 weeks after assignment). In some instances, if a piece or portion of authored content 132 remains unreviewed for a defined interval after assignment to a reviewer 142, the RMS/CMS system 102 autonomously generates and communicates a notification to both the reviewer 142 and one or more additional individuals or roles. The additional individuals or roles receiving such notifications may include, but are not limited to, the reviewer's manager or supervisor, the system manager, or the platform manager.

In some implementations, the RMS/CMS system 102 provides some or all reviewers 142 with the ability to alter, change, or edit some or all of a piece or portion of authored content 132, approved authored content 134a, or unapproved authored content 134b. Providing a reviewer 142 the ability to alter, change, or edit some or all of a piece or portion of authored content 132 facilitates the expeditious approval of the respective piece or portion of authored content (e.g., rather than not approve the authored content, the reviewer can instead edit and approve the edited′ authored content). In some instances, the RMS/CMS system 102 logically associates such alterations, changes, or edits made to authored content by a reviewer 142 with the role and/or identity of the particular reviewer 142. In some instances the RMS/CMS system 102 updates the piece or portion of approved authored content 134a to incorporate the alterations, changes, or edits provided by the reviewer 142. In other instances, the RMS/CMS system 102 stores the alterations, changes, or edits provided by the reviewer 142 as one or more elements logically linked to and logically associated with the respective piece or portion of authored content 132, approved authored content 134a, or unapproved authored content 134b.

The production or manufacturing module 160 receives BOMB 166 for some or all of the makes and models of vehicles 164 produced by one or more OEMs 162. The received BOMB 166 include information or data indicative of the various components and/or systems used in the production of each respective vehicle 164. In at least some implementations, the OEM 162 electronically communicates or otherwise electronically transfers data representative of the information contained on each of the BOMB 166 to the RMS/CMS system 102 via one or more networks 116, 117, such as the Internet. In at least some instances, the electronic BOM data is logically associated with a unique identifier assigned to the vehicle 164 by the OEM 162. For example, the OEM 162 may logically associate BOM data for a vehicle 164 with a unique vehicle identification number (“VIN”) assigned to the respective vehicle 164.

The BOM 166 includes an inventory of the various components and systems used in producing the vehicle 164 with which the respective BOM 166 is associated. As such, the BOM 166 associated with a vehicle 164 provides insight into those topics of interest and/or legally required topics appropriate for inclusion in documentation 184 supplied with or accompanying the vehicle 164. The RMS/CMS system 102 autonomously identifies these topics of interest and legally required topics from the BOM 166 for the vehicle 164. The RMS/CMS system 102 selects pieces or portions of approved authored content 134a logically associated with the identified topics of interest for inclusion in the documentation 184 accompanying the vehicle 164.

For example, the BOM 166 for a first Dodge Ram 1500 pickup may indicate the use of a V-6 gasoline engine. The BOM for a second Dodge Ram 1500 pickup truck may indicate the use of a Cummins supplied turbo-diesel engine. In such a situation, the RMS/CMS system 102 generates documents 184 for the first vehicle that include pieces or portions of approved authored content 134a logically associated with the topics “gasoline engine” and “V-6 Ram” and omits pieces or portions of approved authored content 134a logically associated with the topics of “diesel engine” and “Cummins turbo-diesel RAM.”

The RMS/CMS system 102 may autonomously select the version of the approved authored content 134a included in one or more documents 184 supplied or associated with a particular vehicle 164 based on a defined logical association between an OEM designated language and an OEM designated market for the vehicle 164. In at least some implementations, the RMS/CMS system 102 autonomously determines the OEM designated market for the vehicle 164 using data included by the OEM 162 on the BOM 166 associated with the vehicle 164. The RMS/CMS system 102 autonomously selects the market-appropriate version of approved authored content 134a for inclusion in one or more documents 184 associated with a particular vehicle 164 based on an OEM designated market for the vehicle 164.

The document generation module 180 receives the pieces or portions of approved authored content 134a selected by the RMS/CMS system 102 and assembles the approved authored content 134a into one or more documents 184. Non-limiting example of such documents 184 include owner's guides, quick-start guides, owner's manuals, user's guides, user's manuals, maintenance manuals, system or component specific instruction manuals, supplemental instructions, and the like. The RMS/CMS system 102 has the capability of providing documents 184 in any number of formats that include, but are not limited to, computer readable media, printed publications, and electronically accessible or distributed information.

In many instances, a particular OEM 162 provides the RMS/CMS system 102 with an organizational structure or template for some or all of the documentation 184 provided with the vehicles 164 produced by the respective OEM 162. For example, an OEM 162 may provide an organizational template to the RMS/CMS system 102 delineating a formal or rigid chapter structure for use in documents 184 such as owner's manuals and/or user's guide associated with some or all of the vehicles produced by the OEM 162. For example, an OEM vehicle user's guide may be organized as follows: Chapter 1—Introduction; Chapter 2—Instruments; Chapter 3—Getting Started; Chapter 4—Operating Your Vehicle; Chapter 5—Electronics, etc. Such an organizational template provides consistency in documentation 184 across any number of OEM product lines. The RMS/CMS system 102 stores such OEM specific organizational structures or templates and the logical association between the structure or template and the respective OEM 162 in one or more data stores or databases in the nontransitory storage media 104.

In some instances, portions of such templates may be omitted, where appropriate, from documentation 184. For example, an OEM may provide a template in which Chapter 1 presents pieces or portions of approved authored content 134a related to the engine in a vehicle. Section 1.1 may provide general information logically associated with all engines offered by the OEM 162. Section 1.2 may include portions of approved authored content 134a logically associated with gasoline engines, section 1.3 may include portions of approved authored content 134a logically associated with diesel engines, section 1.4 may include portions of approved authored content 134a logically associated with gasoline/electric hybrid engines, and section 1.5 may include portions of approved authored content 134a logically associated with all engines offered by the OEM 162. In such an instance, a user's guide 184 for a gasoline engine vehicle produced by the OEM would include sections 1.1, 1.2, and 1.5 but would omit sections 1.3 and 1.4 since they are not applicable to the vehicle.

The document generation module 180 includes one or more document generation devices 182. The document generation device 182 includes any device, system, or combination of systems and devices suitable for generating documents 184 including computer readable media 184a, tangible media 184b, and/or electronically distributed documentation 184c. In some instances, documentation 184 in electronic format may be provided to the item of manufacture 164 for presentation on one or more output devices carried by the item of manufacture 164. For example, the documentation 184 may take the form of an electronic file stored in a nontransitory storage media in a vehicle head unit. In some instances, local, state, or federal requirements may stipulate the format for all or a portion of a document. For example, federal law may stipulate that certain vehicle safety information must be provided to consumers in the form of a printed publication 184b.

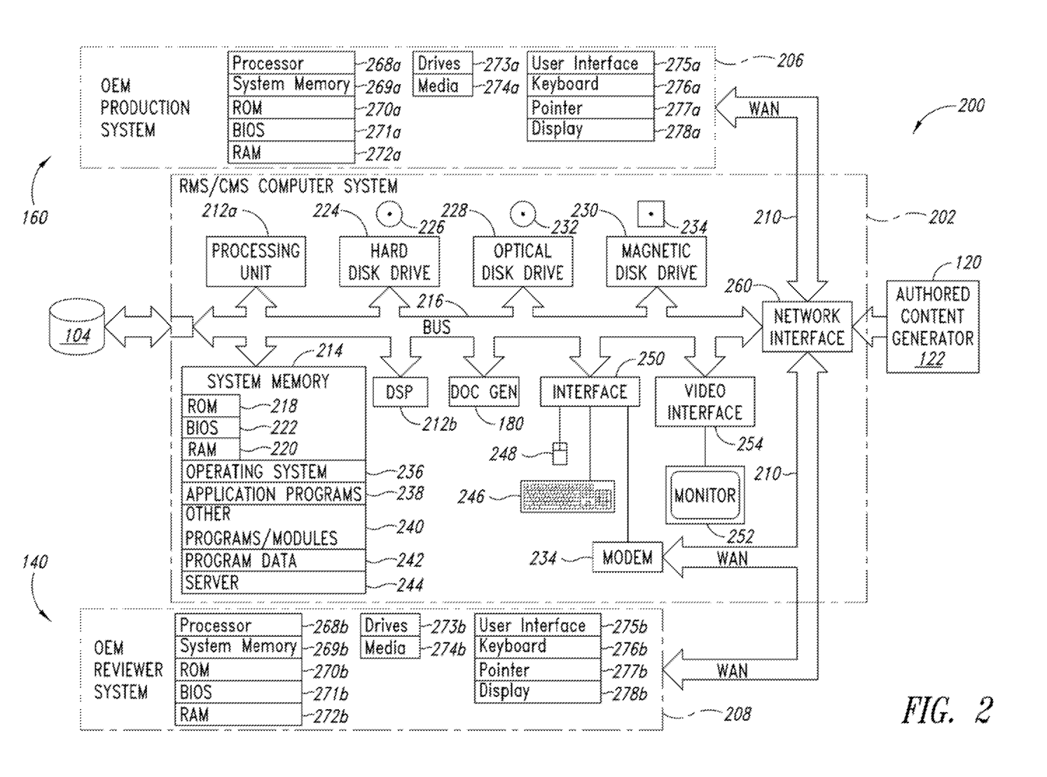

FIG. 2 and the following discussion provide a brief, general description of a suitable networked RMS/CMS system environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 2 shows a networked RMS/CMS system environment 200 comprising one or more RMS/CMS systems 102 (only one illustrated) and one or more associated, communicably coupled, nontransitory computer- or processor readable storage medium 104 (only one illustrated). The associated nontransitory computer- or processor readable storage medium 104 is communicatively coupled to the RMS/CMS system 102 via one or more communications channels, for example one or more parallel cables, serial cables, or wireless channels capable of high speed communications, for instance via Firewire®.

The networked RMS/CMS system environment 200 also comprises one or more OEM production or manufacturing modules 160, that each include one or more OEM production management systems 206 (only one illustrated) and one or more OEM automated tracking and approval notification modules 140, that each include one or more OEM reviewer systems 208 (only one illustrated). The one or more OEM production management systems 206 and the one or more OEM reviewer systems 208 are communicatively coupled to the RMS/CMS system 102 by one or more communications channels, for example one or more wide area networks (WANs) 210, for instance the Internet using Internet protocols. In operation, the one or more OEM production management systems 206 and/or the one or more OEM reviewer systems 208 typically function as either a server to other end user computer systems (i.e., clients) associated with a respective entity (e.g., OEM production or manufacturing, OEM legal, management, and/or technical review groups) or function as end user computer systems (i.e., clients) themselves. In operation, the RMS/CMS system 102 typically functions as a server with respect to the one or more OEM production management systems 206 and/or one or more OEM reviewer systems 208. In some instances, the RMS/CMS system 102 may be collocated within an OEM's production or administrative facilities. In other instances, the RMS/CMS system 102 may be remotely located from an OEM production or administrative facility.

The networked RMS/CMS system environment 200 may employ other computer systems and network equipment, for example additional servers, proxy servers, firewalls, routers and/or bridges. The RMS/CMS system 102 will at times be referred to in the singular herein, but this is not intended to limit the embodiments to a single device since in typical embodiments there may be more than one RMS/CMS system 102 involved. Unless described otherwise, the construction and operation of the various blocks shown in FIG. 2 are of conventional design. As a result, such blocks need not be described in further detail herein, as they will be understood by those skilled in the relevant art.

The RMS/CMS system 102 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the RMS/CMS system 102, such as during start-up.

The RMS/CMS system 102 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer-readable instructions, data structures, program modules and other data for the RMS/CMS system 102. Although the depicted RMS/CMS system 102 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to automatically store pieces or portions of received authored content 132, pieces or portions of approved authored content 134a, and pieces or portions of unapproved authored content 134b to the associated nontransitory computer- or processor readable storage medium 104. Application programs 238 may include instructions that cause the processor(s) 212 to automatically store logical relationships between components and systems used to produce any number of items of manufacture 164 by any number of OEMs 162 with pieces or portions of received authored content 132, pieces or portions of approved authored content 134a, and pieces or portions of unapproved authored content 134b. Application programs 238 may include instructions that cause the processor(s) 212 to store automatically logical relationships between one or more document templates and OEMs 162.

Application programs 238 may include instructions that cause the processor(s) 212 to receive a BOM 166 associated with an item of manufacture 164, determine the components and/or systems used to produce the respective item of manufacture 164, select pieces or portions of approved authored content 134a logically associated with some or all of the identified components and/or systems, and assemble the selected pieces or portions of approved authored content 134a into a document 184 using a template logically associated with an OEM 162 or vehicle 164. Application programs 238 may include instructions that cause the processor(s) 212 to select appropriate versions of approved authored content 134a for inclusion in the document 184 based on at least one of: a language version, a market version, a vehicle 164 model year, a vehicle 164 make, a vehicle 164 model, or combinations thereof.

Application programs 238 may include instructions that cause the processor(s) 212 to RMS/CMS computer system 102 to track the flow of pieces or portions of received authored assets 132 from receipt by the receipt and storage module 120 through the OEM review and approval process using the one or more OEM reviewer systems 208. One or more application programs 238 can autonomously select an appropriate reviewer routing based on one or more classification criteria logically associated with the pieces or portions of received unreviewed authored content 132 and a defined reviewer routing provided the OEM 162. For example, the RMS/CMS system 102 can autonomously determine a routing through an OEM's technical, legal, and management groups based on the classification criteria logically associated with a piece or portion of received unreviewed authored content 132 that is associated with a particular component or system used in a particular make and model vehicle 164 produced by the OEM 162. At times, the RMS/CMS system 102 autonomously determines the roles (e.g., Sr. Ignition System Engineer, Compliance Counsel) of the OEM reviewers 142. At other times, the RMS/CMS system 102 autonomously determines the actual individuals (e.g., Jill Green, Sr. Ignition Systems Engineer; George Dominguez, Compliance Counsel) of the OEM reviewers 142. Application programs 238 cause the RMS/CMS system 102 to generate and transmit notifications indicative of the pieces or portions of received authored content 132 awaiting review to the designated reviewer roles and/or names.

Application programs 238 cause the RMS/CMS system 102 to generate reminders if a reviewer fails to provide a timely review of pieces or portions of received authored content 132 pending review within a defined timeframe (within one week, etc.). In some instances, the RMS.CMS system 102 can generate reminders if a reviewer fails to provide a timely review of pieces or portions of received authored content 132 pending review within a defined timeframe prior to a defined event. For example, the RMS/CMS system 102 may generate a notification 30 days prior to commencing production of vehicles 164 using a component and/or topic logically associated with one or more pieces or portions of authored content 132 pending review by one or more reviewers 142.

Application programs 238 cause the RMS/CMS system 102 to generate and communicate notifications to third parties if a reviewer fails to provide a timely review of pieces or portions of received authored content 132 pending review within a defined timeframe or prior to a defined event. Such third parties may include one or more production managers such as a systems manager or platform manager. Such third parties may include OEM corporate management personnel.

Other program modules 240 may include instructions for handling security such as password or other access protection and communications encryption. The system memory 214 may also include communications programs, for example a server 244 that causes the RMS/CMS system 102 to serve electronic or digital documents or files via corporate intranets, extranets, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

The RMS/CMS system 102 receives commands and other information via input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The RMS/CMS system 102 can include other output devices, such as speakers, printers, etc.

The RMS/CMS system 102 is communicably coupled to the document generation module 180. The document generation module 180 provides the RMS/CMS system 102 to generate output for supply with or to accompany a vehicle 164. The document generation module 180 may include, but is not limited to, any device, system, or combination of current or future systems and devices suitable for generating documents in a nontransitory format. Such document generation module 180 systems and devices include, but are not limited to, one or more computer readable media “burners” capable of writing information to a nontransitory and/or write once/read many (WORM) devices such as compact disc (“CD”), digital versatile disk (“DVD”), Blu-Ray disc, Universal Serial Bus (“USB”) Memory Stick, Secure Digital (“SD”) memory card or similar. Such document generation module 180 systems and devices include, but are not limited to, one or more hardcopy output devices such as sheet-fed printers, bound-copy printers, three-dimensional printers, and similar. Such document generation module 180 systems and devices include, but are not limited to, documents 184 stored in electronic format on nontransitory storage media (e.g., network accessible servers) accessible by one or more computing devices such as portable computing devices, wearable computer devices (e.g., Google® Glass), smartphones, vehicular head units, or similar.

The RMS/CMS system 102 operates in a networked environment using logical connections to one or more remote computers and/or devices. For example, the RMS/CMS system 102 can operate in a networked environment using logical connections to one or more OEM production management systems 206 and one or more OEM reviewer systems 208. Communications may be via tethered and/or wireless network architecture, for instance wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the RMS/CMS system 102 and the one or more OEM production management systems 206 and the one or more OEM reviewer systems 208.

The one or more OEM production management systems 206 and the one or more OEM reviewer systems 208 will typically take the form of end user processor-based devices, for instance one or more enterprise or business management servers 146 executing appropriate instructions. One or more firewalls or similar security devices may be interposed between the RMS/CMS system 102, the one or more OEM production management systems 206 and the one or more OEM reviewer systems 208.

The one or more OEM production management systems 206 and the one or more OEM reviewer systems 208 may include one or more processing units 268a, 268b (collectively 268), system memories 269a, 269b (collectively 269) and a system bus (not shown) that couples various system components including the system memory 269 to the processing unit 268. The one or more OEM production management systems 206 and the one or more OEM reviewer systems 208 will at times each be referred to in the singular herein, but this is not intended to limit the embodiments one or more OEM production management systems 206 and/or the one or more OEM reviewer systems 208. In typical embodiments, there will likely be a large number of communicably coupled OEM production management systems 206 and a similar number of communicably coupled OEM reviewer systems 208.

The processing unit 268 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80x86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the one or more OEM production management systems 206 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270a, 270b (collectively 270) and random access memory (“RAM”) 272a, 272b (collectively 272). A basic input/output system (“BIOS”) 271a, 271b (collectively 271), which can form part of the ROM 270, contains basic routines that help transfer information between elements within the one or more OEM production management systems 206 and the one or more OEM reviewer systems 208 such as during start-up.

The one or more OEM production management systems 206 and the one or more OEM reviewer systems 208 may also include one or more media drives 273a, 273b (collectively 273), e.g., a hard disk drive, magnetic disk drive, WORM drive, and/or optical disk drive, for reading from and writing to computer-readable storage media 274a, 274b (collectively 274), e.g., hard disk, optical disks, and/or magnetic disks. The computer-readable storage media 274 may in some instances, take the form of removable media. For example, hard disks may take the form of a Winchester drives, and optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the one or more OEM production management systems 206 and/or the one or more OEM reviewer systems 208. Although described as employing computer-readable storage media 274 such as hard disks, optical disks and magnetic disks, those skilled in the relevant art will appreciate that one or more OEM production management systems 206 and the one or more OEM reviewer systems 208 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 274.

Program modules, such as an operating system, one or more application programs, other programs or modules and program data, can be stored in the system memory 269. Program modules may include instructions for accessing a Website, extranet site or other site or services (e.g., Web services) and associated WebPages, other pages, screens or services hosted by the RMS/CMS system 102. Program modules may include instructions for storing certain or selected electronic correspondence and/or electronic or digital documents or files (e.g., pieces or portions of received authored content 132, pieces or portions of approved authored content 134a, and pieces or portions of unapproved authored content 134b) or changes thereto to nontransitory computer- or processor readable storage medium, such as local media 274a, 274b. Alternatively, the instructions may cause retrieval of electronic correspondence and/or electronic or digital documents or files or changes to existing electronic correspondence and/or electronic or digital documents or files. Program modules may additionally include instructions for handling security such as ownership, password or other access protection and communications encryption.

In particular, the system memory 269 may include communications programs that permit the one or more OEM production management systems 206 and the one or more OEM reviewer systems 208 to retrieve electronic correspondence and/or electronic or digital documents or files from the associated nontransitory computer- or processor readable storage medium 104. The system memory 269 may additionally include communications programs that permit the one or more OEM production management systems 206 and/or the one or more OEM reviewer systems 208 to gain access to or retrieve electronic correspondence and/or electronic or digital documents or files from the local nontransitory storage media 104, via the RMS/CMS system 102, if the requesting one or more OEM production management systems 206 and/or the one or more OEM reviewer systems 208 have sufficient right, permission, privilege or authority. The system memory 269 may also include other communications programs, for example a Web client or browser that permits the one or more OEM production management systems 206 and one or more OEM reviewer systems 208 to access and exchange data with sources such as Web sites of the Internet, corporate intranets, extranets, or other networks. The browser may, for example be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/modules, program data and/or browser can be stored on the computer-readable storage media 274 of the media drive(s) 273. An operator can enter commands and information into the one or more OEM production management systems 206 and the one or more OEM reviewer systems 208 via a user interface 275a, 275b (collectively 275) through input devices such as a touch screen or keyboard 276a, 276b (collectively 276) and/or a pointing device 277a, 277b (collectively 277) such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278a, 278b (collectively 278) may be coupled to the system bus via a video interface, such as a video adapter. The one or more OEM production management systems 206 can include other output devices, such as speakers, printers, etc.

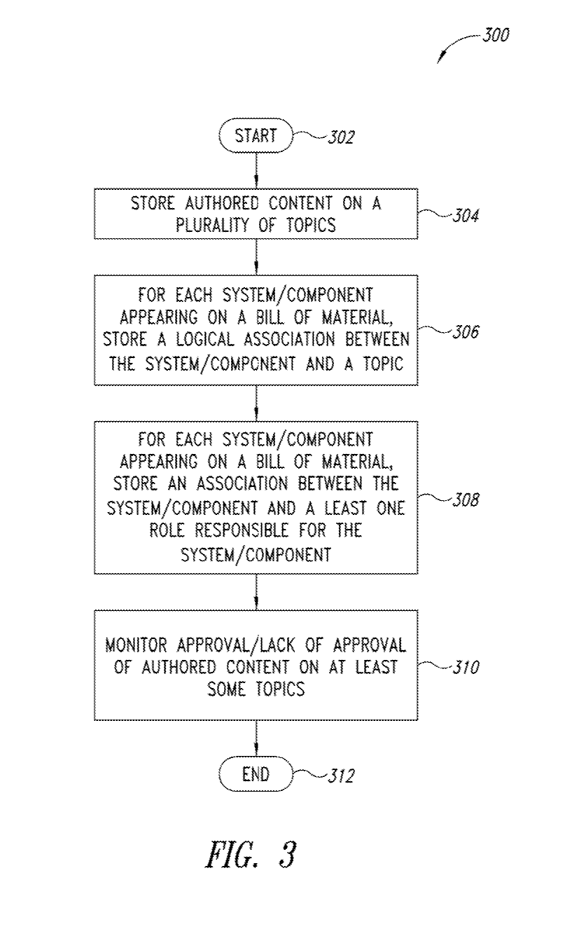

FIG. 3 is a high-level logic diagram of an example method 300 of receiving pieces or portions of authored content 132 that are each logically associated with components and/or systems used in a number of vehicles 164. The method 300 also tracks the progress of each OEM's review process for each piece or portion of received authored content 132, according to one non-limiting illustrated embodiment. The RMS/CMS system 102 can autonomously route the pieces or portions of received authored content 132 through a defined sequence, series, or group of reviewers at the direction of each respective OEM 162. The RMS/CMS system 102 can track comments, alterations, edits, and changes made to some or all of the pieces or portions of received authored content 132, and may logically associate such comments, alterations, edits, and changes with a particular OEM reviewer role (e.g., Sr. Ignition Engineer) and/or OEM reviewer name (e.g., Jill Green). Reviewed pieces or portions of received authored content 132 can be classified as either approved authored content 134a (i.e. authored content approved for use in documents 184) or unapproved authored content (i.e., authored content not approved for use in documents 184).

The RMS/CMS system 102 may track an OEM review process and issue reminders and/or notifications based on temporal criteria, event-driven criteria, or a combination thereof. For example, the RMS/CMS system 102 may generate and electronically communicate a reminder to a reviewer 142 if the status of piece or portion of received authored content 132 that is pending their review has not been provided within a defined timeframe or prior to a defined event. The RMS/CMS system 102 may generate and communicate notifications to one or more third parties (e.g., production management personnel and/or business management personnel) if the status of a piece or portion of received authored content 132 that is pending a reviewer's 142 approval or disapproval has not been provided within a defined timeframe or prior to a defined event. The method of autonomously receiving, assigning, and tracking an OEM authored content review process using an RMS/CMS system 102 commences at 302.

At 304, the RMS/CMS system 102 receives and stores one or more pieces or portions of authored content 132 in one or more databases 128. In at least some instances, the one or more databases 128 are stored or otherwise retained in one or more nontransitory storage media 124 individually or collectively communicably coupled with the RMS/CMS system 102 via one or more networks 112. Any number of internal or external sources 122 provides the pieces or portions of authored content 132. Such pieces or portions of received authored content 132 may include data representative of textual content, audio content, video content, graphical content, audio/visual content, or combinations thereof. Such pieces or portions of received unreviewed authored content 132 may range in size from a single image and/or several words, to any number of images or illustrations and/or multiple paragraphs of text.

Each of the pieces or portions of received authored content 132 are logically associated with one or more available topics that may or may not be included in documentation 184 that accompanies a vehicle 164 based on the specific build configuration of a particular vehicle. At times, the source 122 of the respective piece or portion of received authored content 132 may provide the data indicative of such topical logical associations. At times, the RMS/CMS system 102 may autonomously, manually, or semi-autonomously provide data indicative of such topical logical associations. In some instances, the OEM may provide association data with which the RMS/CMS system 102 may create or otherwise form and store one or more logical associations.

Further, the RMS/CMS system 102 logically associates parts, components, systems, or similar information found on the BOM 166 for a particular vehicle 164 with one or more required topics included in documentation 184 that supplied with or accompanying a vehicle 164. The RMS/CMS system 102 receives BOMB 166 for some or all of the vehicles 164 produced by one or more OEMs 162. Each of the received BOMB 166 carries data indicative of a number of systems and/or components used to produce the vehicle 164.

Using the data obtained from the received BOMB 166, the RMS/CMS system 102 determines one or more topics logically associated with the components or systems included on each BOM 166. By matching the required topics determined using a vehicle BOM 166 with pieces or portions of approved authored content 134a logically associated with the same or a similar topic, the RMS/CMS system 102 assembles the documentation 184. In some instances, the RMS/CMS system 102 assembles the documentation 184 using one or more OEM-specific document templates.

At 306, the RMS/CMS system 102 forms and stores in the nontransitory storage media 104, a logical association between each of the components and systems included in a BOM 166 one or more topics for inclusion in the documentation 184 accompanying a vehicle 164. For example, a BOM 166 including components specific to a convertible top may be logically associated with topics such as “raising and lowering a convertible top” and “convertible top care” that are typically included in documents such as the owner's manual and user guide supplied with or accompanying the vehicle 164. The RMS/CMS system 102 may store such logical associations in the form of data in the nontransitory storage media 104. Such logical associations may be formed by the RMS/CMS system 102 or provided to the RMS/CMS system 102 by an OEM 164, provided to the RMS/CMS system 102 by a supplier 122, or any combination thereof.

At 308, the RMS/CMS system 102 stores data indicative of a logical association between one or more reviewers 142 and a component or system appearing on a BOM 166. For example, the RMS/CMS system 102 may generate data indicative of a logical association between a particular system or component and/or a particular class of components or systems and number of OEM selected or designated reviewers 142 having a recognized level of experience, expertise, or knowledge of the respective components or systems. As one or more sources 122 provide pieces or portions of authored content 132 to the RMS/CMS system 102, the system may autonomously assign OEM selected reviewers 142 and/or an OEM designated sequence of reviewers 142 based on the system or component associated with the respective piece or portion of received authored content 132.

In at least some instances, the RMS/CMS system 132 autonomously generates and communicates a notification to a group of reviewers 142 designated by each respective OEM 162. In at least some instances, such autonomously generated and communicated notifications can include information indicative of the pieces or portions of received authored content 132 that are pending review by the respective reviewer 142. At times, the autonomously generated and communicated notification can include a file attachment containing the pieces or portions of received authored content 132. At times, the autonomously generated and communicated notification can include one or more links (e.g., HTML links) to a storage location where the pieces or portions of received authored content 132 are stored or otherwise retained, such as the nontransitory storage 124.

In at least some instances, the RMS/CMS system 102 can record temporal information (e.g., day and date) that a piece or portion of received authored content 132 was communicated to a particular reviewer 142. In other instances, the RMS/CMS system 102 can monitor the temporal difference between the time that piece or portion of received authored content 132 was communicated to a particular reviewer 142 and the time that a particular component or system logically associated with the respective component or system is scheduled to enter the production of one or more vehicles 164. Such temporal monitoring advantageously provides the RMS/CMS system 102 with the ability to ensure timely review of pieces or portions of received authored content 132 by one or more OEM selected reviewers 142.

At 310, the RMS/CMS system 102 autonomously monitors the progress of the review process for each of the reviewers 142. In at least some instances, the RMS/CMS system monitors the progress based on whether a particular reviewer 142 has designated a piece or portion of received authored content 132 as either approved authored content 134a or unapproved authored content 134b. At times, the RMS/CMS system 102 can generate and communicate one or more “received authored content pending review” status reports to one or more OEMs 162. Such reports may be made available to the OEM 162 via the OEM's enterprise or business management system 146. Such reports may include information such as the number pieces or portions of received authored content 132 pending review by a particular reviewer 142, the number of pieces or portions of received authored content 132 reviewed by the reviewer 142, and similar.

The method of autonomously receiving, assigning, and tracking an OEM authored content review process using an RMS/CMS system 102 concludes at 312.

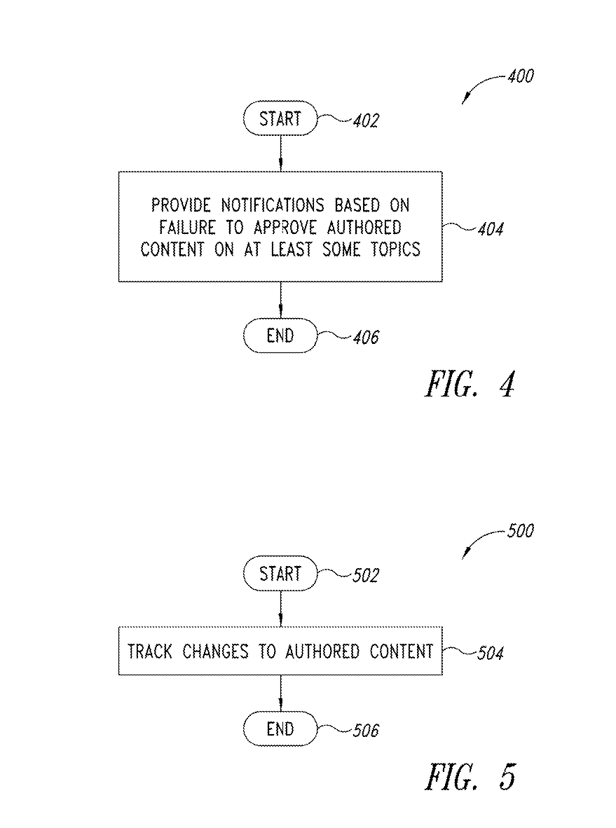

FIG. 4 shows a flow diagram of a method 400 by which the RMS/CMS system 102 generates notifications or reminders indicative of a reviewer's failure to review piece or portion of received authored content 132 within a defined timeframe or prior to a defined event. The RMS/CMS system 102 generates and communicates notifications to a reviewer 142 based on the presence of one or more pieces or portions of received authored content 132 pending review by the respective reviewer 142. In such instances, the reviewer 142 may be identified by name, by role, or a combination thereof. In such instances, the reviewer 142 may include a single individual or may include a group that includes a plurality of individuals.

At times, after distributing the pieces or portions of received authored content 132 to a number of reviewers 142, some of the reviewers 142 may not provide the RMS/CMS system 102 with a review in a timely manner. For example, a reviewer 142 may not provide a review to the RMS/CMS system 102 within a timeframe (within 7 days, within 15 days, within 30 days, etc.) defined by the OEM 162. In another example, a reviewer 142 may not provide a review to the RMS/CMS system 102 within a defined timeframe prior to an event (at least 7 days prior to a vehicle 164 going into production, etc.). The method of providing notifications of pieces or portions of received authored content 132 pending review by one or more reviewers 142 commences at 402.

At 404, the RMS/CMS system 102 generates and communicates notifications of pieces or portions of received authored content 132 pending review by one or more reviewers 142. In at least some instances, the RMS/CMS system generates such notifications on a temporal basis, for example after the passing of a defined period of time subsequent to the initial receipt of the respective piece or portions of authored content 132 by the reviewer 142. In other instances, the RMS/CMS system generates such notifications on an event driven basis. For example, the RMS/CMS system 102 may generate a notification at a defined period in advance of the use of the component or system logically associated with the respective piece or portion of received authored content 132 in the production of a vehicle 164.

The RMS/CMS system 102 may communicate some or all of the notifications in electronic form to some or all of the reviewers 142. In some instances at least a portion of the notifications may be communicated via one or more enterprise or business management systems 146.

The RMS/CMS system 102 may generate and communicate a number of different communications to a number of different recipients based on OEM preferences. For example, the RMS/CMS system 102 may communicate a first reminder via a notification communicated directly to the reviewer after the passage of a first defined time period (e.g., 2 weeks after receipt of the piece or portion of received authored content 132). In some instances, the RMS/CMS system 102 may communicate a second reminder via a notification communicated directly to the reviewer after the passage of a second defined time period (e.g., 3 weeks after receipt of the piece or portion of received authored content 132). In some instances, the RMS/CMS system 102 may communicate a third reminder via a notification communicated directly to a manager (e.g., a systems manager) after the passage of a third defined time period (e.g., 4 weeks after receipt of the piece or portion of received authored content 132). In some instances, the RMS/CMS system 102 may communicate a fourth reminder via a notification communicated directly to a manager responsible for at least a portion of the vehicle 164 (e.g., a platform manager) after the passage of a fourth defined time period (e.g., 5 weeks after receipt of the piece or portion of received authored content 132). The method of providing notifications of pieces or portions of received authored content 132 pending review by one or more reviewers 142 concludes at 406.

FIG. 5 shows a flow diagram of a method 500 by which the RMS/CMS system 102 tracks changes made to pieces or portions of received authored content 132 by one or more reviewers 142. In some instances, rather than simply not approve a piece or portion of received authored content 132, a reviewer may instead edit, change, or otherwise alter some or all of the respective piece or portion of received authored content 132. In at least some implementations, the RMS/CMS system 102 may logically associate such changes to the piece or portion of received authored content 132 with the respective, resultant piece or portion of approved authored content 134a or unapproved authored content 134b. By tracking the changes made by one or more reviewers 142, the history and/or evolution of the resultant piece or portion of approved authored content 134a is accessible to other reviewers, OEM legal, and OEM management personnel. The method 500 of tracking via the RMS/CMS system 102 changes made by one or more reviewers 142 to some or all of a piece or portion of received authored content 132 commences at 502.

At 504, the RMS/CMS system 102 tracks the changes made to some or all of a piece or portion of received authored content 132 by one or more reviewers 142. Such changes may be limited in scope or may include significant revisions or changes to some or all of a piece or portion of received authored content 132. In some instances, the RMS/CMS system 102 tracks the changes by saving any old deleted or overwritten data as well as any new data added by the reviewer 142. The RMS/CMS system 102 can logically associate such data with the respective, resultant, piece or portion of approved authored content 134a. In some instances, the RMS/CMS system 102 stores additional information including at least some of the following: the identity of the reviewer 142 making the revision or change, the role of the reviewer 142 making the revision or change, the time and/or date of the change, or any combination thereof.

In some instances, the RMS/CMS system 102 may determine that a change or edit made by a reviewer 142 to a piece or portion of received authored content 132 that has not yet completed the review process requires a re-review by one or more prior reviewers 142. In such instances, the RMS/CMS system 102 may autonomously reroute the amended piece or portion of received authored content 132 through some or all of the review process.

In some instances, the RMS/CMS system 102 may prevent a reviewer 142 from editing, changing, or altering some or all of a piece or portion of received authored content 132. For example, a block of unreviewed authored content 132 may include a technical portion and a legal portion. In such instances, the RMS/CMS system 102 may prevent a technical reviewer 142a from editing or changing the content of the legal portion. Similarly, the RMS/CMS system 102 may prevent a legal reviewer 142b from editing or changing the content of the technical portion. The method 500 of tracking via the RMS/CMS system 102 changes made by one or more reviewers 142 to some or all of a piece or portion of received authored content 132 concludes at 506.

FIG. 6 shows a flow diagram of a method 600 by which the RMS/CMS system 102 tracks reviewer comments appended to a piece or portion of received authored content 132. In some instances, a reviewer 142 may desire to pass along information in the form of comments to subsequent technical reviewers 142a, legal reviewers 142b, and/or management reviewers 142c. Such comments may include information that assists subsequent reviewers in their review and/or evaluation of the respective piece or portion of received authored content 132. In at least some implementations, the RMS/CMS system may logically associate such comments with the respective piece or portion of received authored content 132. The method 600 of tracking reviewer comments logically associated with a piece or portion of received authored content 132 commences at 602.

At 604, the RMS/CMS system 102 tracks comments provided by one or more reviewers 142 by appending or otherwise logically associating the comment with the respective piece or portion of received authored content 132. In some instances, the RMS/CMS system 102 tracks the comments by saving and logically associating the comments with the resultant piece or portion of approved authored content 134a or the resultant piece or portion of unapproved authored content 134b. In some instances, the RMS/CMS system 102 stores additional information including at least some of the following: the identity of the reviewer 142 providing the comment, the role of the reviewer 142 providing the comment, the time and/or date that the reviewer 142 provided the comment, or any combination thereof. The method 600 of tracking reviewer comments logically associated with a piece or portion of received authored content 132 concludes at 606.

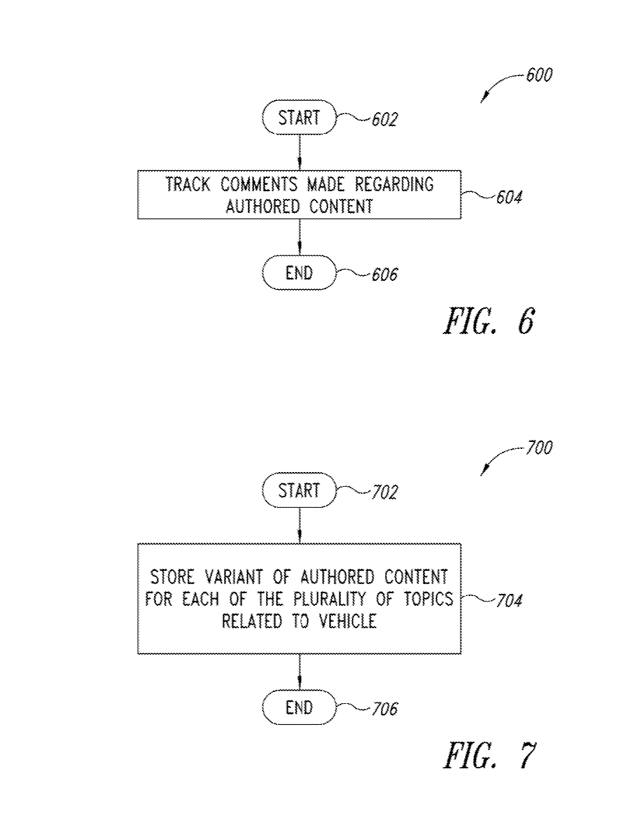

FIG. 7 shows a flow diagram of a method 700 by which the RMS/CMS system 102 stores any number of variants of approved authored content 134a. Many manufacturers have a presence in diverse markets in which different languages, practices, cultures, and legal requirements may be present. To address these variations in language, culture, and legal requirements OEMs 162 may provide documentation 184 in a particular language, tailored to a market or containing legal required sections. Substantively, the content of the pieces or portions of approved content 134a included in the variant documents 184 may be similar or identical. The method 700 of storing variants of approved authored content 134a in the RMS/CMS system 102 commences at 702.

At 704, the RMS/CMS system 102 stores one or more variants of approved authored content 134a. In at least some instances, the one or more variants of approved authored content 134a may be stored in one or more databases 128. In at least some instances, additional data (e.g., metadata or similar identifying data) is logically associated with some or all of the respective piece or portion of approved authored content 134a. Such additional data may include data indicative of one or more of the following: the language of the approved authored content 134a; the intended culture for the approved authored content 134a; the intended market of the approved authored content 134a.

When the RMS/CMS system 102 generates documentation 184 for a particular language, culture, or market, the RMS/CMS system 102 may autonomously select a variant of the approved authored content 134a appropriate to the language, culture, or market for inclusion in the document 184. In some instances, the RMS/CMS system 102 may autonomously determine the particular language, culture, or market for which the vehicle 164 is destined based on information or data included in the BOM 166 associated with the respective vehicle 164. The method 700 of storing variants of approved authored content 134a in the RMS/CMS system 102 concludes at 702.

The various methods described herein may include additional acts, omit some acts, and/or may perform the acts in a different order than set out in the various flow diagrams.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via one or more microcontrollers. However, those skilled in the art will recognize that the embodiments disclosed herein, in whole or in part, can be equivalently implemented in standard integrated circuits (e.g., Application Specific Integrated Circuits or ASICs), as one or more computer programs executed by one or more computers (e.g., as one or more programs running on one or more computer systems), as one or more programs executed by on one or more controllers (e.g., microcontrollers), as one or more programs executed by one or more processors (e.g., microprocessors), as firmware, or as virtually any combination thereof, and that designing the circuitry and/or writing the code for the software and/or firmware would be well within the skill of one of ordinary skill in the art in light of the teachings of this disclosure.

When logic is implemented as software and stored in memory, logic or information can be stored on any non-transitory computer-readable medium for use by or in connection with any processor-related system or method. In the context of this disclosure, a memory is a nontransitory computer- or processor-readable storage medium that is an electronic, magnetic, optical, or other physical device or means that non-transitorily contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any physical element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), and digital tape.

The various embodiments described above can be combined to provide further embodiments. All of the commonly assigned US patent application publications, US patent applications, foreign patents, and foreign patent applications referred to in this specification and/or listed in the Application Data Sheet, including but not limited to U.S. Provisional Application Ser. No. 61/903,780, filed Nov. 13, 2014, are incorporated herein by reference, in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

While generally discussed in the environment and context of power system for use with personal transportation vehicle such as all-electric scooters and/or motorbikes, the teachings herein can be applied in a wide variety of other environments, including other vehicular as well as non-vehicular environments.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a vehicle component authoring system comprising at least one processor and at least one nontransitory processor-readable medium communicatively coupled to the at least one processor, the method comprising:
for each of a number of documents,
storing a set of authored content by the at least one processor to the at least one nontransitory processor-readable medium, the stored set of authored content including authored content for each of a plurality of topics related to the vehicle;
for each of a plurality of systems and components which are each represented by a respective identifier in a bill of materials for the vehicle, storing a logical relationship between the respective system or the respective component of the vehicle and a respective one of the topics, by the at least one processor to the at least one nontransitory processor-readable medium;
for each of a plurality of systems and components which are each represented by a respective identifier in a bill of materials for the vehicle, storing a logical relationship between the respective system or the respective component of the vehicle and at least one respective role responsible for the respective system or the respective component, by the at least one processor to the at least one nontransitory processor-readable medium; and
monitoring approval or lack of approval of at least a portion of the set of authored content by the at least one processor.

2. The method of claim 1 wherein monitoring approval or lack of approval of at least a portion of the set of authored content by the at least one processor includes monitoring approval or lack of approval on a topic level, on a system or component level, and on a complete authored document level.

3. The method of claim 1 wherein storing a logical relationship between the respective system or the respective component of the vehicle and at least one respective role responsible for the respective system or the respective component includes storing a respective logical relationship between the system or the component and an identifier that identifies at least one of a position or a title.

4. The method of claim 3, further comprising:
storing a logical relationship between the identifier that identifies at least one of the position or the title and an identifier that uniquely identifies an individual currently assigned to the respective position or the respective title.

5. The method of claim 4, further comprising:
from time-to-time, updating the stored logical relationship between the identifier that identifies at least one of the position or the title and the identifier that uniquely identifies the individual currently assigned to the respective position or the respective title as the individual currently assigned to the respective position or the respective title changes.

6. The method of claim 1 wherein storing a logical relationship between the respective system or the respective component of the vehicle and at least one respective role responsible for the respective system or the respective component includes storing a respective logical relationship between the system or the component and an identifier that identifies a plurality of at least one of a position or a title.

7. The method of claim 1 wherein monitoring approval or lack of approval of the authored content of the set of authored content includes, for each system or each component, storing a set of information which indicates which of the respective roles logically associated with the respective system or respective component have approved the respective portion of the authored content.

8. The method of claim 7 wherein monitoring approval or lack of approval of the authored content of the set of authored content includes identifying any of the systems or the components which have not been approved by all of the respective roles logically associated with the respective system or the respective component, and causing a notification indicative of the lack of approval to be provided.

9. The method of claim 8 wherein causing a notification indicative of the lack of approval to be provided includes causing a first electronic communication to be provided to any individuals who are logically assigned to the respective roles logically associated with the respective system or the respective component, and who have not yet approved the authored content logically associated with the respective system or the respective component.

10. The method of claim 9 wherein causing a notification indicative of the lack of approval to be provided further includes, after causing the first electronic notification to be provided, causing a second electronic communication to be provided to any individuals who are logically assigned to the respective roles logically associated with the respective system or the respective component, and who have still not yet approved the authored content logically associated with the respective system or the respective component.

11. The method of claim 10 wherein causing a notification indicative of the lack of approval to be provided includes causing a third electronic communication to be provided to at least one supervisor of any individuals who are logically assigned to the respective roles logically associated with the respective system or respective component and which individuals have not yet approved the authored content logically associated with the respective system or the respective component.

12. The method of claim 11 wherein causing a notification indicative of the lack of approval to be provided further includes, waiting after the provision of the second electronic communication before causing the third electronic communication to be provided to the at least one supervisor.

13. The method of claim 12 wherein causing a notification indicative of the lack of approval to be provided further includes determining when to cause the third electronic communication to be provided to the at least one supervisor based on a release schedule.

14. The method of claim 12 wherein causing a notification indicative of the lack of approval to be provided further includes causing a fourth electronic communication to be provided to any individuals who are logically assigned to a role that provides overall responsibility for the authored content for the vehicle.

15. The method of claim 14 wherein causing a notification indicative of the lack of approval to be provided further includes, waiting after the provision of the third electronic communication before causing the fourth electronic communication to be provided to the at least one supervisor.

16. The method of claim 15 wherein causing a notification indicative of the lack of approval to be provided further includes determining when to cause the provision of the fourth electronic communication to the at least one supervisor based on a release schedule.

17. The method of claim 7 wherein causing a notification indicative of the lack of approval to be provided includes causing an electronic communication to be provided to at least one supervisor of any individuals who are logically assigned to the respective roles logically associated with the respective system or respective component and which individuals have not yet approved the authored content logically associated with the respective system or the respective component.

18. The method of claim 1 wherein the set of authored content is at least one of the plurality of systems and components which is represented by at least one respective part identifier in the bill of materials for the vehicle, and storing a logical relationship between the respective system or the respective component of the vehicle and at least one respective role responsible for the respective system or the respective component includes storing a respective logical relationship between the set of authored content and at least one respective role responsible for the set of authored content.

19. The method of claim 1 wherein monitoring approval or lack of approval of at least a portion of the set of authored content by the at least one processor includes monitoring approval or lack of approval for each logically associated role on a topic level, on a system or component level, and on a complete authored document level.

20. The method of claim 1, further comprising:
tracking by the at least one processor changes to the authored content.

21. The method of claim 20 wherein tracking by the at least one processor changes to the authored content includes storing a logical relationship between each change a respective unique identifier of a subject matter expert who was responsible for the change.

22. The method of claim 20, further comprising:
storing the changes as a respective annotation to the authored content.

23. The method of claim 1, further comprising:
tracking by the at least one processor comments made with respect to the authored content.

24. The method of claim 20 wherein tracking by the at least one processor comments made with respect to the authored content includes storing a logical relationship between each comment a respective unique identifier of a subject matter expert who was responsible for the comment.

25. The method of claim 20, further comprising:
storing the comments as a respective annotation to the authored content.

26. The method of claim 1 wherein storing a set of authored content by the at least one processor to the at least one nontransitory processor-readable medium, includes storing a variant of authored content for each of a plurality of topics related to the vehicle.

27. The method of claim 26 wherein the stored authored content is in a first language and storing a variant of authored content for each of a plurality of topics related to the vehicle includes storing a version of the authored content in a second language different from the first language.

28. The method of claim 26 wherein the stored authored content is customized for a first market and storing a variant of authored content for each of a plurality of topics related to the vehicle includes storing a version of the authored content customized for a second market, different than the first market.

29. The method of claim 28 wherein storing a version of the authored content customized for a second market, different than the first market, includes storing a variant of the authored content for the second market with at least one system or component that is different from the stored authored content for the first market.

30. The method of claim 28 wherein storing a version of the authored content customized for a second market, different than the first market, includes storing a variant of the authored content for the second market with at least one safety warning that is different from the stored authored content for the first market.

31. The method of claim 1 wherein the identifiers in the bill of materials correspond to respective original equipment manufacturer part identifiers for the respective vehicle.

32. An authoring system, comprising:
at least one processor;
at least one nontransitory processor-readable medium communicatively coupled to the at least one processor, and which stores at least one of processor-executable instructions or data, where for each of a number of documents:
the at least one processor stores a set of authored content to the at least one nontransitory processor-readable medium, the stored set of authored content including authored content for each of a plurality of topics related to the vehicle;
for each of a plurality of systems and components which are each represented by a respective identifier in a bill of materials for the vehicle, the at least one processor stores a logical relationship between the respective system or the respective component of the vehicle and a respective one of the topics to the at least one nontransitory processor-readable medium;
for each of a plurality of systems and components which are each represented by a respective identifier in a bill of materials for the vehicle, the at least one processor stores a logical relationship between the respective system or the respective component of the vehicle and at least one respective role responsible for the respective system or the respective component to the at least one nontransitory processor-readable medium; and
the at least one processor monitors approval or lack of approval of at least a portion of the set of authored content.

33-57. (canceled)
